(19) United States
(12) Patent Application Publication
(10) Pub. No.: US 2004/0257490 A1
(43) Pub. Date: Dec. 23, 2004

(54) LCD device having a combined bezel and front housing

(76) Inventor: Yi-Lun Ho, Kao-Hsiung Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/462,652

(22) Filed: Jun. 17, 2003

(51) Int. Cl. G02F 1/1333

(52) U.S. Cl. 349/58

(57) ABSTRACT

A liquid crystal display (LCD) device includes an LCD panel for displaying images, a panel bezel, and a rear housing. The panel bezel contains a side plate formed on a perimeter of the panel bezel for enclosing a perimeter of the LCD panel, and a front plate monolithically formed with the side plate for enclosing a front surface of the LCD panel and acting as a front housing of the LCD device. The front plate has a viewing hole for allowing the LCD panel to be viewed through the front plate, and a plurality of holes for receiving input keys. The LCD device also contains a plurality of input keys disposed in the corresponding holes of the front plate for receiving input commands of the LCD device. The rear housing is attached to the panel bezel for enclosing the LCD panel between the panel bezel and the rear housing.

### BACKGROUND OF INVENTION

1. Field of the Invention

The present invention relates to a liquid crystal display (LCD) device, and more specifically, to an LCD device with a panel bezel that combines the functions of a front housing and a bezel.

2. Description of the Prior Art

Liquid crystal display (LCD) devices are quickly becoming preferred display devices due to their small size and low power consumption. Because many LCD devices are used in portable electronic devices such as notebook computers, personal digital assistants (PDAs), mobile phones, etc., a recent trend has been to reduce the size of LCD devices as much as possible.

Please refer to FIG. 1. FIG. 1 is an exploded view of an LCD device 10 according to the prior art. The LCD device 10 contains an LCD panel module 40 that is used for displaying images. A bezel 30 is fitted over the LCD panel module 40 for protecting an outer perimeter of the LCD panel module 40. A circuit board 45 is disposed on a rear side of the LCD panel module 40 for controlling operation of the LCD device 10. During assembly of the LCD device 10, a front housing 20 is fitted over the bezel 30 of the LCD panel module 40. A viewing hole 22 is formed in the front housing 20 for allowing a user of the LCD device 10 to view images displayed by the LCD panel module 40. The front housing 20 contains a plurality of input buttons 24 for allowing the user to input commands to the LCD device 10, such as OSD commands. The input buttons 24 are electrically connected to the circuit board 45, and the circuit board 45 executes commands given by the user through the input buttons 24. The front housing 20 also contains a plurality of screw receptacles 26, each screw receptacle 26 formed for receiving a screw used in assembly. Finally, a rear housing 50 is placed over the front housing 20, thereby enclosing the bezel 30, the LCD panel module 40, and the circuit board 45. The rear housing 50 is secured to the front housing 20 with a plurality of screws 54. The screws 54 are inserted through corresponding openings 52 in a backside of the rear housing 50, and are then secured to the corresponding screw receptacles 26 in the front housing 20.

The LCD device 10 shown in FIG. 1 has a fairly simple structure. However, both the bezel 30 and the front housing 20 surround the outside perimeter of the LCD panel module 40. Please refer to FIG. 2. FIG. 2 is a rear view of the LCD device 10 shown in FIG. 1 during assembly. As can be seen, the circuit board 45 is disposed behind the LCD panel module 40. The bezel 30 is fitted around the LCD panel module 40, and the front housing 20 surrounds the bezel 30. While the bezel 30 typically has a small outer thickness, the front housing 20 is much larger. Therefore, the bezel 30 and the front housing 20 add considerable height and width to the LCD device 10, which makes the LCD device 10 less suitable for electronic devices with a size constraint, such as slim notebook computers. Unfortunately, no matter what size LCD panel module 40 is used, the use of both the bezel 30 and the front housing 20 will add extra height and width to the LCD device 10.

### SUMMARY OF INVENTION

It is therefore a primary objective of the claimed invention to provide an LCD device with a panel bezel that combines the functions of a front housing and a bezel in order to solve the above-mentioned problems.

According to the claimed invention, a liquid crystal display (LCD) device includes an LCD panel for displaying images and a panel bezel. The panel bezel contains a side plate formed on a perimeter of the panel bezel for enclosing a perimeter of the LCD panel, and a front plate monolithically formed with the side plate for enclosing a front surface of the LCD panel and acting as a front housing of the LCD device. The front plate has a viewing hole for allowing the LCD panel to be viewed through the front plate, and a plurality of holes for receiving input keys. The LCD device also contains a plurality of input keys disposed in the corresponding holes of the front plate for receiving input commands of the LCD device, and a rear housing attached to the panel bezel for enclosing the LCD panel between the panel bezel and the rear housing.

It is an advantage of the claimed invention that the panel bezel encloses the LCD panel and acts as a front housing of the LCD device for reducing the height and width of the LCD device. The LCD device of the claimed invention has minimized dimensions, and is perfectly suited as a slim LCD device.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is an exploded view of an LCD device according to the prior art.

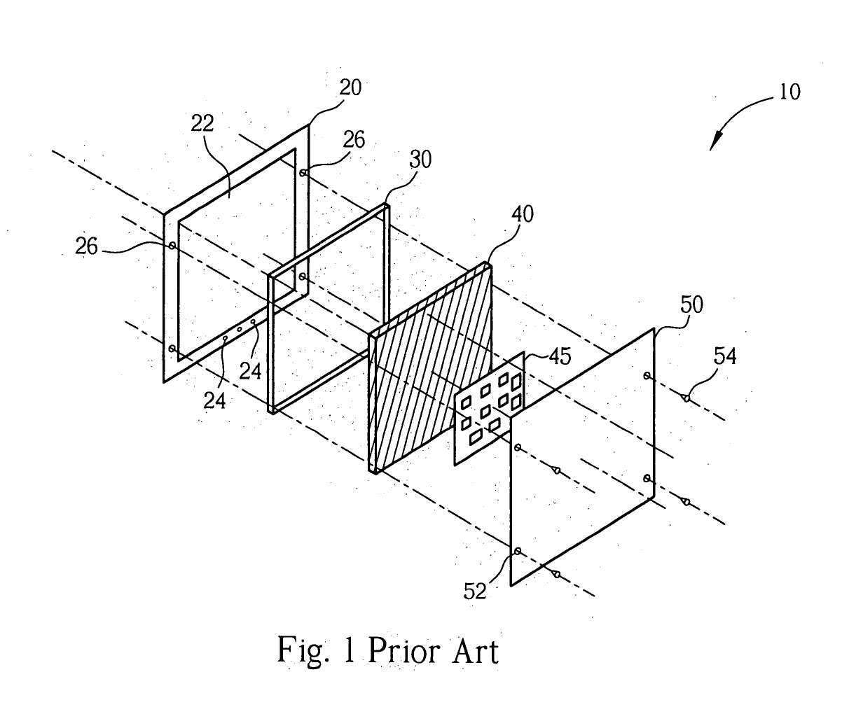

FIG. 2 is a rear view of the LCD device shown in FIG. 1 during assembly.

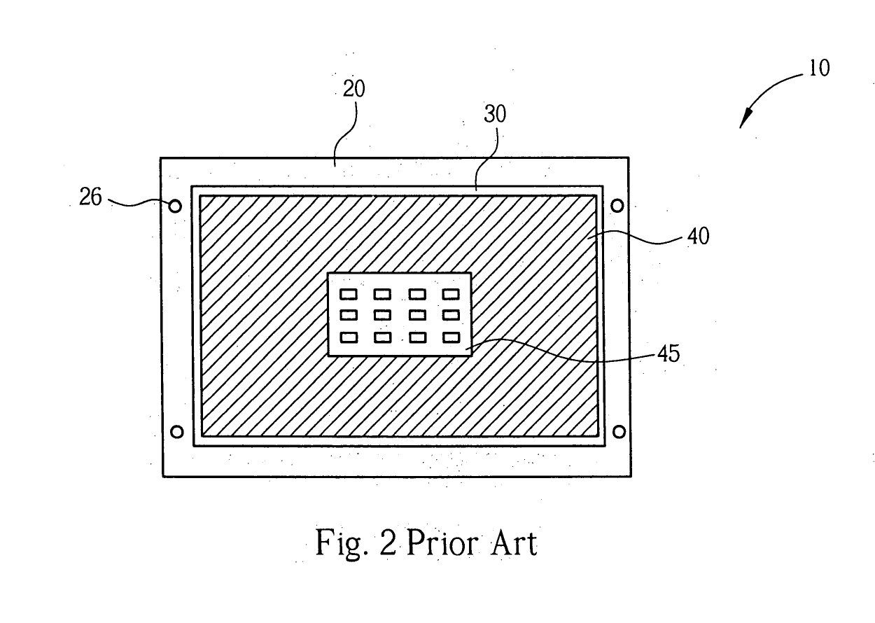

FIG. 3 is a rear view of an LCD device during assembly according to the present invention.

FIG. 4 is an exploded view of the LCD device shown in FIG. 3.

FIG. 5 is a front view of the LCD device shown in FIG. 3.

FIG. 6 is a bottom view of the LCD device.

FIG. 7 is a cross-sectional view of the LCD device taken from the area surrounded by dotted line AA in FIG. 6.

FIG. 8 is a simplified cross-sectional view of the LCD device taken from the area surrounded by dotted line AA in FIG. 6.

FIG. 9 is a right-hand side view of the LCD device.

FIG. 10 is a cross-sectional view of the LCD device taken from the area surrounded by dotted line BB of FIG. 9.

FIG. 11 is a flowchart showing a sample listing of the assembly process according to the present invention.

### DETAILED DESCRIPTION

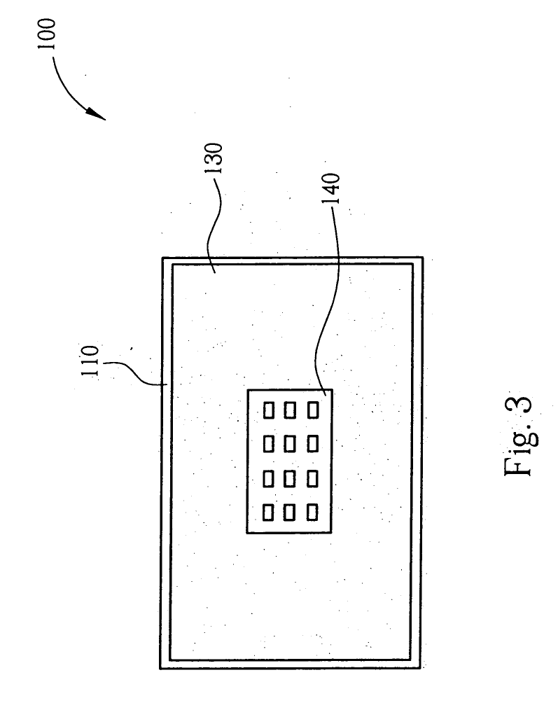

Please refer to FIG. 3. FIG. 3 is a rear view of an LCD device 100 during assembly according to the present invention. The LCD device 100 includes an LCD panel module 130 for displaying images. A circuit board 140 is disposed on a rear side of the LCD panel module 130 for controlling operation of the LCD device 100. A panel bezel 110 is fitted over the LCD panel module 130. The panel bezel is not only used for protecting an outer perimeter of the LCD panel module 130, but also for acting as a front housing of the LCD panel module 130. As can be seen, since the panel bezel 110 combines the functionality of a bezel and a front housing, the LCD device 100 can have very slim dimensions. In fact, the total height and width of the LCD device 100 are just slightly larger than the height and width of the LCD panel module 130.

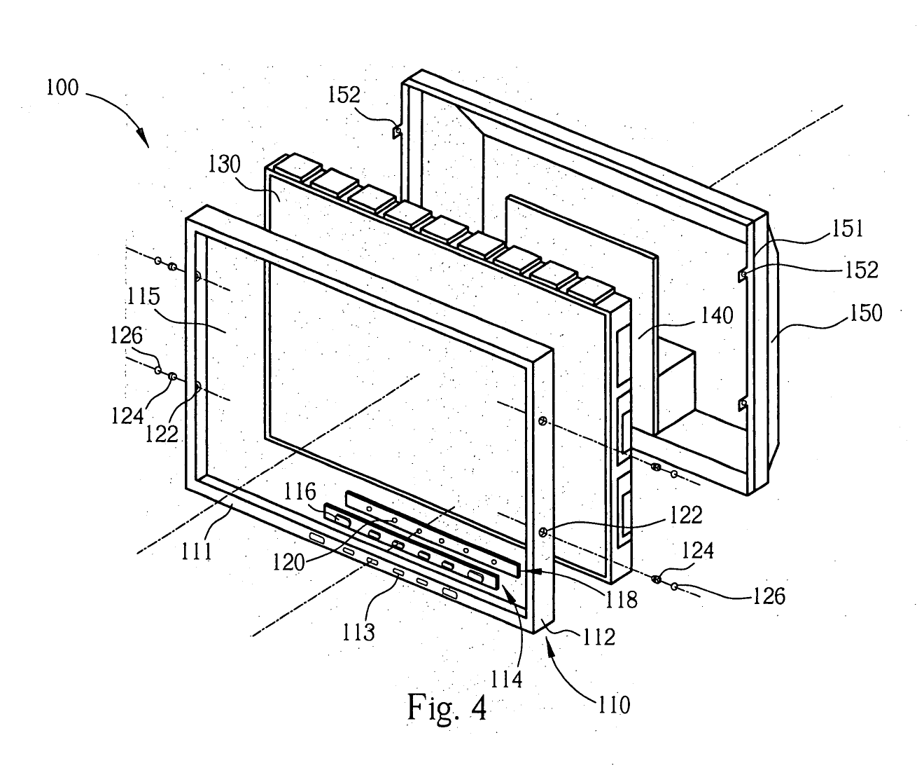

Please refer to FIG. 4. FIG. 4 is an exploded view of the LCD device 100 shown in FIG. 3. The panel bezel 110 contains a front plate 111 for covering a front side of an outer perimeter of the LCD panel module 130, and a side plate 112 for covering the top, bottom, left, and right sides of the LCD panel module 130. A viewing hole 115 is formed for allowing a user to see images displayed by the LCD panel module 130 through the panel bezel 110. A keypad 114 is disposed behind the front plate 111 of the panel bezel 110 for allowing the user to input commands to the LCD device 100. The keypad 114 contains a plurality of input keys 116, and each of the input keys 116 are inserted into corresponding holes 113 in the front plate 111 of the panel bezel 110. A control pad 118 is then disposed behind the keypad 114 for receiving input signals form the input keys 116 and for providing the input signals to the circuit board 140. The control pad 118 contains a plurality of sensors 120, each sensor 120 being used for detecting input signals from the corresponding input keys 116 on the keypad 114.

Next, a rear housing 150 is placed over the panel bezel 110, thereby enclosing the LCD panel module 130 and the circuit board 140 between the panel bezel 110 and the rear housing 150. The rear housing 150 contains a side flap 151 formed on top, bottom, left, and right sides of the rear housing 150. When assembling the rear housing 150, the side flap 151 of the rear housing 150 is inserted between the side plate 112 of the panel bezel 110 and the LCD panel module 130. The rear housing 150 is secured to the panel bezel 110 with a plurality of screws 124. The side flap 151 of the rear housing 150 contains a plurality of screw receptacles 152 for receiving the screws 124, and the side plate 112 of the panel bezel 110 contains a plurality of openings 122. Each screw 124 is inserted through the corresponding opening 122 of the side plate 112, and is then secured to the corresponding screw receptacle 152 of the side flap 151, thus fastening the rear housing 150 to the panel bezel 110. After the screws 124 are fastened into place, each of the openings 122 is covered with an insulation pad 126 for protecting the screws 124 and for improving the appearance of the LCD device 100.

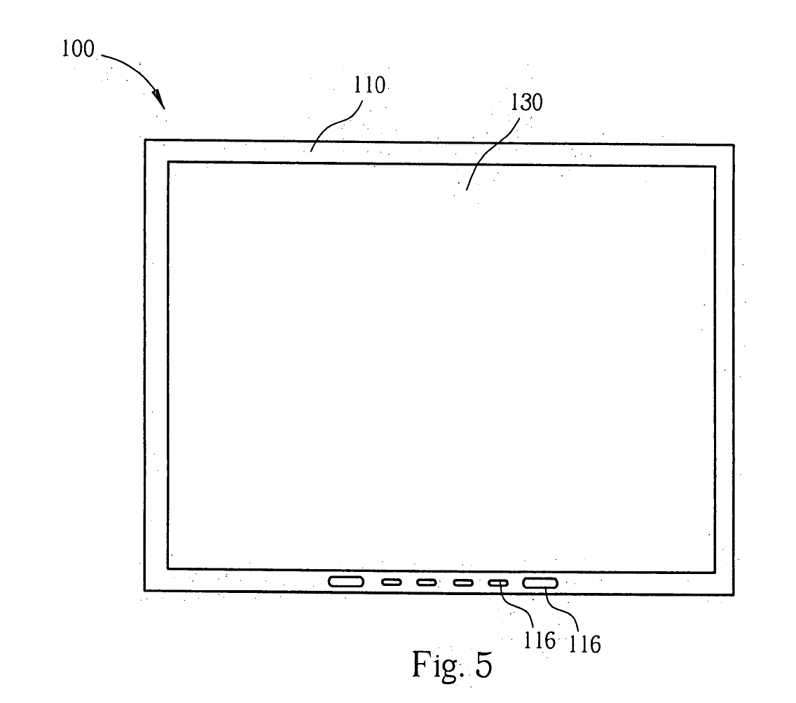

Please refer to FIG. 5. FIG. 5 is a front view of the LCD device 100 shown in FIG. 3. The panel bezel 110 is shown surrounding an outer perimeter of the LCD panel module 130. The input keys 116 are formed on the panel bezel 110 for allowing the user to easily change settings of the LCD device 100, such as through an on screen display (OSD). Because only the panel bezel 110 is disposed around the perimeter of the LCD panel module 130, the LCD device 100 has a height and width that are not much larger than the height and width of the LCD panel module 130.

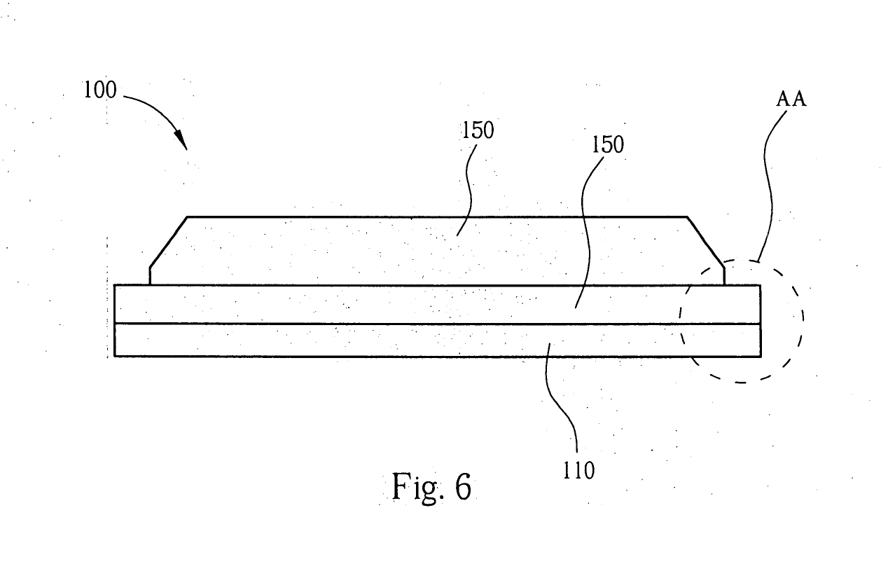

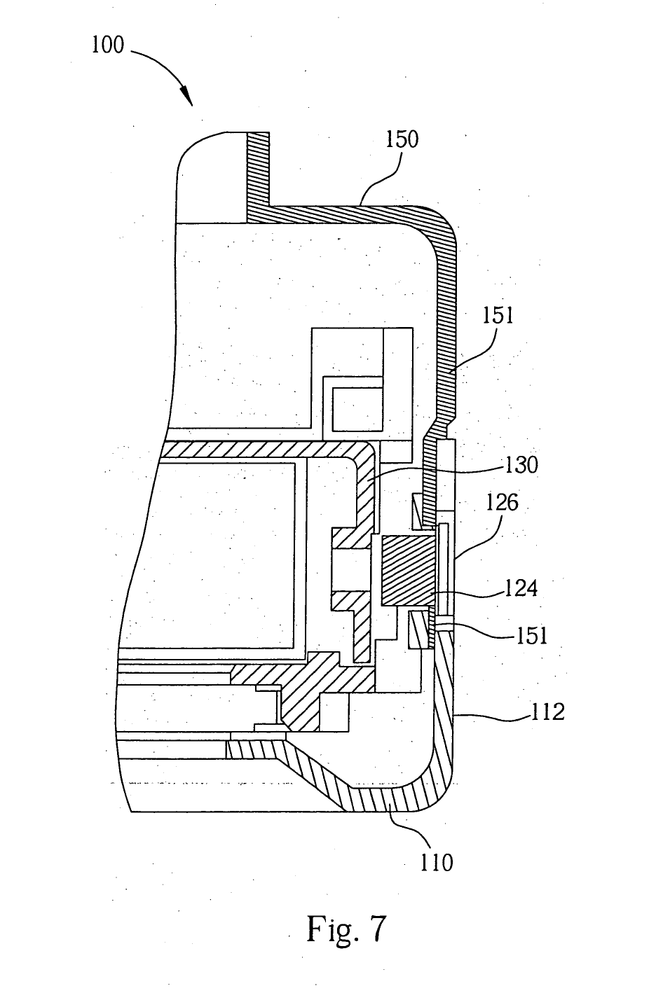

Please refer to FIG. 6 and FIG. 7. FIG. 6 is a bottom view of the LCD device 100. The rear housing 150 is shown disposed on the panel bezel 110. FIG. 7 is a cross-sectional view of the LCD device 100 taken from the area surrounded by dotted line AA in FIG. 6. The side flap 151 of the rear housing 150 is shown as being inserted between the LCD panel module 130 and side plate 112 of the panel bezel 110. The screws 124 are then inserted into the screw receptacles 152 of the side flap 151 through the openings 122 of the side plate 112. Finally, the insulation pads 126 are then disposed over the screws 124 in the openings 122 of the side plate 112.

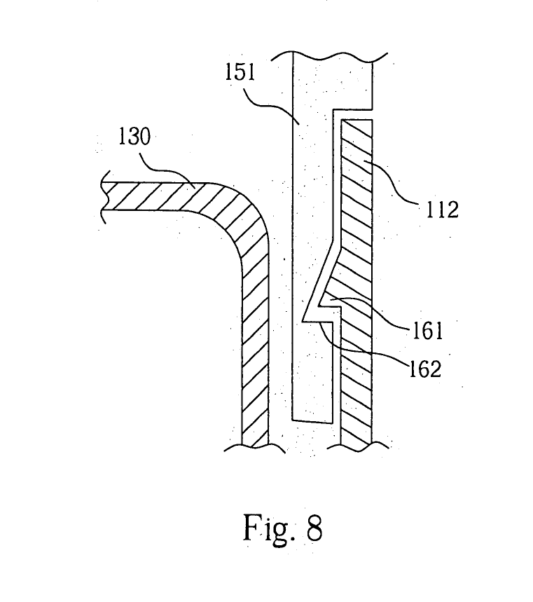

Please refer to FIG. 8. FIG. 8 is a simplified cross-sectional view of the LCD device 100 taken from the area surrounded by dotted line AA in FIG. 6. The side flap 151 of the rear housing 150 is shown as having a slot 162 in which a protruding edge 161 of the side plate 112 latches into. Thus, when placing the rear housing 150 on the panel bezel 110 during assembly, the side flap 151 of the rear housing 150 is inserted between the LCD panel module 130 and the side plate 112 of the panel bezel 110. The protruding edge 161 of the side plate 112 then latches into the slot 162 of the side flap 151. After the rear housing 150 and the panel bezel 110 are latched together, the screws 124 are then used to securely fasten the rear housing 150 to the panel bezel 110.

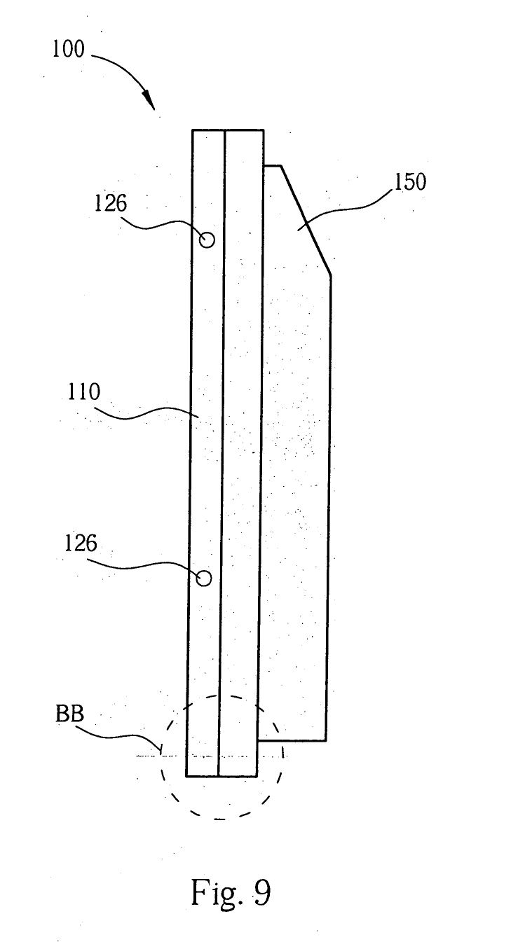

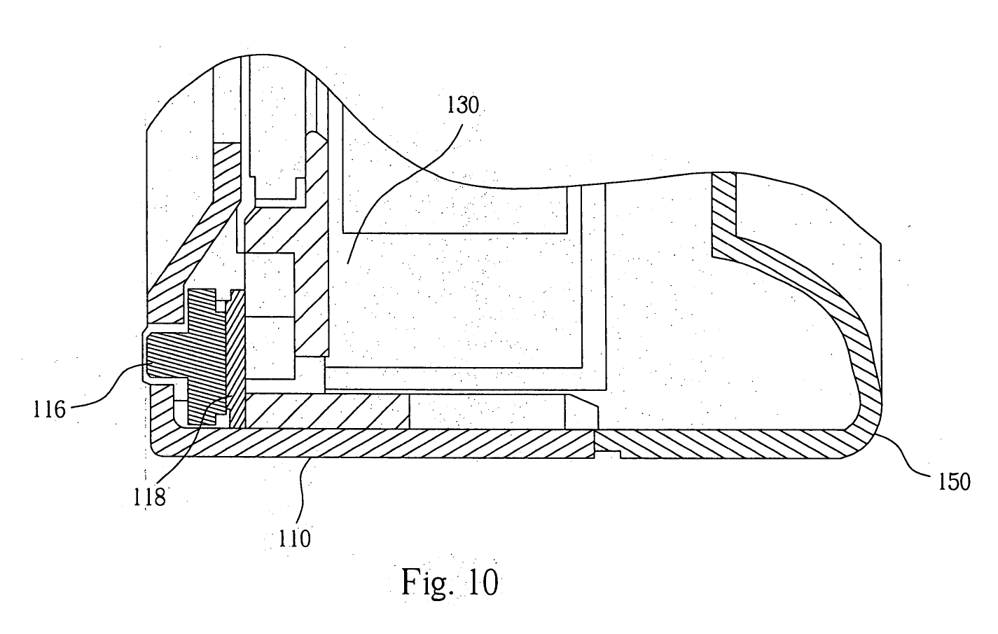

Please refer to FIG. 9 and FIG. 10. FIG. 9 is a right-hand side view of the LCD device 100. In FIG. 9, the insulation pads 126 can be seen covering the screws 124 that are used to secure the rear housing 150 to the panel bezel 110. FIG. 10 is a cross-sectional view of the LCD device 100 taken from the area surrounded by dotted line BB of FIG. 9. As can be seen in FIG. 10, a bottom portion of the panel bezel 110 is curved outward from the LCD panel module 130. This small outward curve offers sufficient space for accommodating the keypad 114 containing the input keys 116 and the control pad 118 disposed behind the keypad 114. Please note that if no input keys 116 are used in the LCD device 100, the outward curve of the panel bezel 110 can be eliminated since no keypad 114 or control pad 118 will be used.

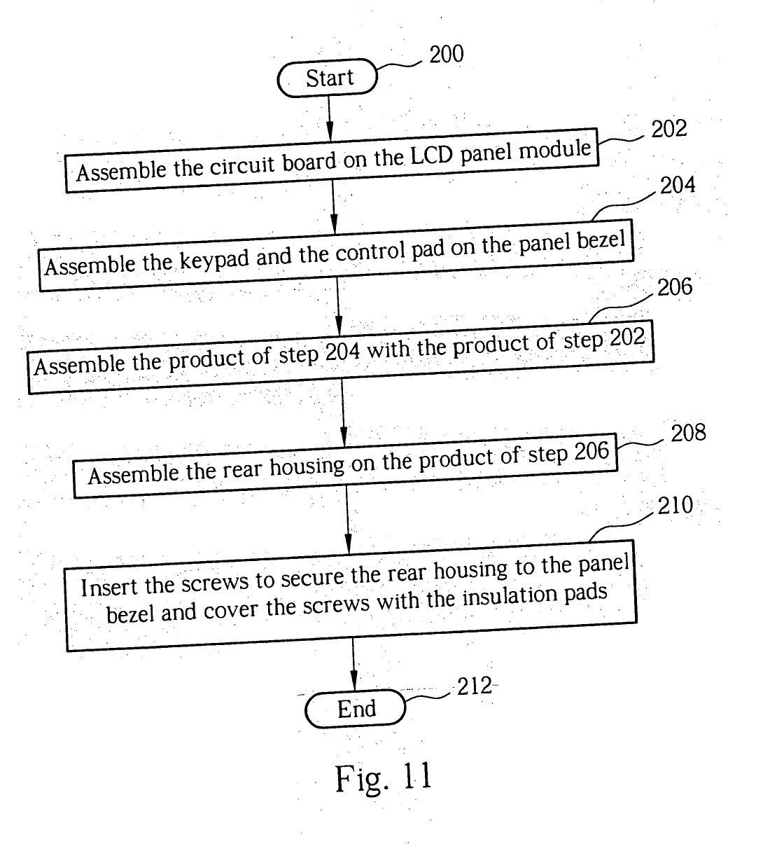

The present invention simplifies the assembly process for the LCD device 100 while simultaneously reducing the width and height of the LCD device 100. Please refer to FIG. 11. FIG. 11 is a flowchart showing a sample listing of the assembly process according to the present invention. Steps contained in the flowchart will be explained below.

Step 200: Start;

Step 202: Assemble the circuit board 140 with the LCD panel module 130;

Step 204: Assemble the keypad 114 and the control pad 118 on the panel bezel 110;

Step 206: Assemble the panel bezel 110 containing the keypad 114 and control pad 118 (product of step 204) with the LCD panel module 130 containing the circuit board 140 (product of step 202);

Step 208: Assemble the rear housing 150 on the product of step 206;

Step 210: Insert the screws 124 to secure the rear housing 150 to the panel bezel 110 and cover the screws 124 with the insulation pads 126; and

Step 212: End.

Please note that the steps in the flowchart of FIG. 11 can also be completed in different sequences, as is known by those skilled in the art. For example, step 204 can be completed before step 202.

Compared to the prior art, the present invention LCD device 100 combines the functionality of the prior art bezel and front housing into the single panel bezel 110. Not only does this simplify the assembly process, but the LCD device 100 can also be made with a smaller height and width. Therefore, the LCD device 100 is perfectly suited as a slim LCD device. Since the assembly process is simplified, and fewer parts are required, the present invention LCD device 100 saves cost while at the same time reducing size dimensions of the LCD device 100.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A liquid crystal display (LCD) device comprising:
an LCD panel for displaying images;
a panel bezel comprising:
a side plate formed on a perimeter of the panel bezel for enclosing a perimeter of the LCD panel; and
a front plate monolithically formed with the side plate for enclosing a front surface of the LCD panel and acting as a front housing of the LCD device, the front plate having a viewing hole for allowing the LCD panel to be viewed through the front plate, and a plurality of holes for receiving input keys;
a plurality of input keys disposed in the corresponding holes of the front plate for receiving input commands of the LCD device; and
a rear housing attached to the panel bezel for enclosing the LCD panel between the panel bezel and the rear housing.

2. The LCD device of claim 1 further comprising a circuit board disposed between the LCD panel and the rear housing for controlling operations of the LCD device.

3. The LCD device of claim 1 wherein the input keys are formed on a keypad, and the keypad is disposed between the panel bezel and the LCD panel for inserting the input keys into the corresponding holes in the front plate.

4. The LCD device of claim 3 further comprising a control pad disposed between the keypad and the LCD panel for receiving input signals from the input keys and transmitting the input signals to the circuit board.

5. The LCD device of claim 1 wherein the rear housing comprises a side flap formed on the perimeter of the rear housing, the side flap formed for insertion between the side plate of the panel bezel and the LCD panel.

6. The LCD device of claim 5 wherein the side plate of the panel bezel comprises a plurality of openings, the side flap of the rear housing comprises a plurality of screw receptacles corresponding to the plurality of openings on the side plate, and the LCD panel further comprises a plurality of screws inserted into the screw receptacles through the openings for securing the rear housing to the panel bezel.

7. The LCD device of claim 6 further comprising a plurality of insulation pads disposed over corresponding screws in the openings of the side flap for covering the screws.

8. The LCD device of claim 5 wherein the side plate of the panel bezel comprises a protruding edge, the side flap of the rear housing comprises a slot corresponding to the protruding edge, and the LCD panel is assembled between the rear housing and the panel bezel by positioning the protruding edge of the panel bezel into the slot of the rear housing.

9. A method of assembling a liquid crystal display (LCD) device, the method comprising steps of:
(a) providing a panel bezel, the panel bezel comprising:
a side plate formed on a perimeter of the panel bezel for enclosing a perimeter of the LCD panel; and
a front plate monolithically formed with the side plate for enclosing a front surface of the LCD panel and acting as a front housing of the LCD device, the front plate having a viewing hole for allowing the LCD panel to be viewed through the front plate, and a plurality of holes for receiving input keys;
(b) providing an LCD panel for displaying images;
(c) disposing the panel bezel on the LCD panel;
(d) disposing a plurality of input keys in the corresponding holes of the front plate for receiving input commands of the LCD device; and
(e) attaching a rear housing to the panel bezel for enclosing the LCD panel between the panel bezel and the rear housing.

10. The method of claim 9 further comprising disposing a circuit board between the LCD panel and the rear housing, the circuit board being used for controlling operations of the LCD device.

11. The method of claim 9 wherein the input keys are formed on a keypad, and the method further comprises a step (d2) of disposing the keypad between the panel bezel and the LCD panel for inserting the input keys into the corresponding holes in the front plate.

12. The method of claim 11, further comprising a step (d3) of disposing a control pad between the keypad and the LCD panel, the control pad being used for receiving input signals from the input keys and transmitting the input signals to the circuit board.

13. The method of claim 9 wherein the rear housing comprises a side flap formed on the perimeter of the rear housing, and the method further comprises a step (e2) of inserting the side flap of the rear housing between the side plate of the panel bezel and the LCD panel.

14. The method of claim 13 wherein the side plate of the panel bezel comprises a plurality of openings and the side flap of the rear housing comprises a plurality of screw receptacles corresponding to the plurality of openings on the side plate, and the method further comprises a step (e3) of inserting a plurality of screws into the screw receptacles through the openings for securing the rear housing to the panel bezel.

15. The method of claim 14, further comprising a step (e4) of disposing a plurality of insulation pads over corresponding screws in the openings of the side flap for covering the screws.

16. The method of claim 13 wherein the side plate of the panel bezel comprises a protruding edge, the side flap of the rear housing comprises a slot corresponding to the protruding edge, and the method further comprises a step of positioning the protruding edge into the slot for securing the rear housing to the panel bezel.
